(19) United States
(12) Patent Application Publication
(10) Pub. No.: US 2017/0048790 A1
(43) Pub. Date: Feb. 16, 2017

(54) METHODS AND APPARATUSES FOR PROVIDING QUALITY OF SERVICE DEPENDENT SERVICES TO MOBILE CLIENTS IN MULTIPLE BACKHAUL ENVIRONMENTS

(71) Applicant: QUALCOMM Incorporated, San Diego, CA (US)

(72) Inventors: Chaitanya Pratapa, Hyderabad (IN); Rohit Tripathi, San Diego, CA (US); Gaurav Gopal Kathuria, San Diego, CA (US)

(21) Appl. No.: 14/826,041

(22) Filed: Aug. 13, 2015

(51) Int. Cl. H04W 48/18; H04L 29/06

(52) U.S. Cl. CPC H04W 48/18; H04L 65/1016; H04L 65/1006; H04W 84/042

(57) ABSTRACT

In one aspect, wireless communications may be provided by routing packets from a wireless communication device to a wide area network via a first network, wherein the packets comprise data for a first service and a second service. Upon determining that a second network is assigned as a default network, data for the first service and the second service may be selectively assigned the to the first network or the second network based at least in part upon whether the second network is assigned as the default network and further based at least in part on a quality of service requirement of the first service and the second service respectively. The first service may comprise an IP multimedia subsystem (IMS) service. The first network can comprise a wireless wide area network (WWAN), and the second network can comprise a wireless local area network (WLAN) or an Ethernet network.

### BACKGROUND

Field

The present application relates generally to wireless communications, and more specifically to providing quality of service dependent services to mobile clients in multiple backhaul environments.

Background

Wireless communication systems are widely deployed to provide various types of communication content such as voice, video and/or data. A mobile access point is one type of device which provides network services to one or more client devices. The network services provided by the mobile access point may be determined based on the network to which the mobile access point is connected. For example, a mobile access point may be configured to connect, as a client, to multiple networks such as a cellular network, fiber optic network, Ethernet, Wi-Fi network, or the like. The mobile access point may then provide Wi-Fi access to client devices.

Some mobile access point implementations provide quality of service (QOS) guarantees for applications utilizing the access point, while others do not. Further, some mobile access points provide additional functionalities that are not available over other access points. However, there may be advantages provided by the other access points based on different capabilities provided thereby. Accordingly, it may be advantageous to utilize multiple access points or networks at a time.

### SUMMARY

Various implementations of methods and apparatus within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims.

One aspect of the present disclosure provides a method of providing wireless communications. The method includes routing packets from a wireless communication device to a wide area network via a first network, the packets comprising data for a first service and a second service. The method further includes determining whether a second network is assigned as a default network. The method further includes selectively assigning the data for the first service and the second service to the first network or the second network based at least in part upon whether the second network is assigned as the default network and further based at least in part on a quality of service requirement of the first service and the second service respectively. In some aspects the first network comprises a wireless wide area network (WWAN), the second network comprises a wireless local area network (WLAN) or an Ethernet network, and the first service comprises a service requiring a minimum quality of service. In one aspect, the first service is an IP multimedia subsystem (IMS) service, such as IMS voice.

Another aspect provides an apparatus configured to provide wireless communications. The apparatus includes a processor configured to route packets from a wireless communication device to a wide area network via a first network, the packets comprising data for a first service and a second service. The processor is further configured to determine whether a second network is assigned as a default network. The processor is further configured to selectively assign the data for the first service and the second service to the first network or the second network based at least in part upon whether the second network is assigned as the default network and further based at least in part on a quality of service requirement of the first service and the second service respectively. In some aspects the first network comprises a wireless wide area network (WWAN), the second network comprises a wireless local area network (WLAN) or an Ethernet network, and the first service comprises a service requiring a minimum quality of service. In one aspect, the first service is an IP multimedia subsystem (IMS) service, such as IMS voice.

Another aspect provides another apparatus configured to provide wireless communications. The apparatus includes means for routing packets from a wireless communication device to a wide area network via a first network, the packets comprising data for a first service and a second service. The apparatus further includes means for determining whether a second network is assigned as a default network. The apparatus further includes means for selectively assigning the data for the first service and the second service to the first network or the second network based at least in part upon whether the second network is assigned as the default network and further based at least in part on a quality of service requirement of the first service and the second service respectively. In some aspects the first network comprises a wireless wide area network (WWAN), the second network comprises a wireless local area network (WLAN) or an Ethernet network, and the first service comprises a service requiring a minimum quality of service. In one aspect, the first service is an IP multimedia subsystem (IMS) service, such as IMS voice.

Another aspect provides a non-transitory computer readable medium. The medium includes code that, when executed, performs a method of providing wireless communications. The method includes routing packets from a wireless communication device to a wide area network via a first network, the packets comprising data for a first service and a second service. The method further includes determining that a second network is assigned as a default network. The method further includes selectively assigning the data for the first service and the second service to the first network or the second network based at least in part upon whether the second network is assigned as the default network and further based at least in part on a quality of service requirement of the first service and the second service respectively. In some aspects the first network comprises a wireless wide area network (WWAN), the second network comprises a wireless local area network (WLAN) or an Ethernet network, and the first service comprises a service requiring a minimum quality of service. In one aspect, the first service is an IP multimedia subsystem (IMS) service, such as IMS voice.

### BRIEF DESCRIPTION OF THE DRAWINGS

FIG. 1 illustrates a network diagram of an example of a wireless communication network in which aspects of the present disclosure may be employed.

FIG. 2 illustrates an example of a functional block diagram of a SoftAP that may be employed within the wireless communication networks of FIG. 1.

FIG. 3 illustrates another example of the wireless communication network in which aspects of the present disclosure may be employed.

FIG. 4 illustrates a flow diagram of a method of providing wireless communications.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Client devices accessing a network can encounter issues when accessing the network via a mobile access point. For example, the mobile access point may be configured to map its default communication interface to a third party Wi-Fi access point or Ethernet connection (e.g., via USB), such as provided in a hotel, office, coffee shop, library, etc. Clients of the mobile access point may, therefore, communicate with Internet service provider servers via the third party connection rather than another network connection of the mobile access point such as a cellular connection. The data path for traffic from the client may flow via Wi-Fi or Ethernet from the client to the mobile access point and then via Wi-Fi or Ethernet from the mobile access point to the third party access point who will then route the communication to the Internet service provider server.

Connected clients can experience data services access failures caused by the Wi-Fi or Ethernet access. For example, the Wi-Fi or Ethernet access may block websites due to firewalls, or may not support or may block Virtual Private Networks or other service types. The Wi-Fi or Ethernet access may not support requested application layer gateways like SIP (or other voice over MIFI feature), TFTP, RTSP, video streaming, etc. Additionally or alternatively, the Wi-Fi or Ethernet access may not provide quality of service (QOS) guarantees for data services provided.

As a result of these failures, connected clients end up with bad user experience. The experience may be poor due to stalled or terminated browsing session(s), or because one or more DNS queries for the service may fail. The experience may be poor due to stalled or terminated IP multimedia subsystem (IMS) services, such as an IMS voice call being dropped or terminated. Furthermore, the client and the mobile access point may spend valuable resources such as a power, processor time, airtime, bandwidth, and memory, to attempt connections to servers which are not permitted by the network, or which are otherwise inefficient.

In the case of mobile access points with available Wi-Fi, Ethernet, and/or cellular networks, the network having the higher signal strength may be selected for network communications. Thus, if the Wi-Fi signal of a third party access point is higher than the cellular signal, the data path may switch from cellular to the third party Wi-Fi, even if the Wi-Fi path may result in a poor user experience (e.g., stalled or terminated services). Similarly, in the case of mobile access points with available Ethernet and cellular networks, the Ethernet path may be selected over the cellular network(s), even if the Ethernet path may result in a poor user experience (e.g., stalled or terminated services).

The features described in further detail below can be applied to reduce the likelihood of stalled or terminated services experienced by the mobile access point or client devices to provide efficient switching between a first network, which may provide reliable communications for a particular service (e.g., IMS or other QOS dependent services), and a second network, which may provide unreliable communications for the service. For example, in some aspects, mobile access point devices may provide client devices access to an internet service provider. The mobile access point may first communicate with the internet service provider via a cellular connection, and may later determine that a Wi-Fi connection or an Ethernet connection is available. As the Wi-Fi or Ethernet connections may cause data service access failures, allowing the mobile access point device to dynamically determine which mode of connection will be used for different services to reach an internet service provider, more efficient service provisioning may be provided to the client devices. Policy based routes, for example, may be maintained at the mobile access point device which route some packets over the cellular network path, while other packets may be routed over a Wi-Fi or Ethernet communication path.

Various aspects of the novel systems, apparatuses, and methods are described more fully hereinafter with reference to the accompanying drawings. The teachings of this disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The word “exemplary” is used herein to mean “serving as an example, instance, or illustration.” Any implementation described herein as “exemplary” is not necessarily to be construed as preferred or advantageous over other implementations. The following description is presented to enable any person skilled in the art to make and use the invention. Details are set forth in the following description for purpose of explanation. The invention may be practiced without the use of these specific details. In other instances, well known structures and processes are not elaborated in order not to obscure the description of the invention with unnecessary details. Thus, the present invention is not intended to be limited by the implementations shown, but is to be accorded with the widest scope consistent with the principles and features disclosed herein.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2). These various radio technologies and standards are known in the art.

It should be emphasized that the disclosed techniques may also be applicable to technologies and the associated standards related to LTE Advanced, LTE, W-CDMA, TDMA, OFDMA, High Rate Packet Data (HRPD), Evolved High Rate Packet Data (eHRPD), Worldwide Interoperability for Microwave Access (WiMax), GSM, enhanced data rate for GSM evolution (EDGE), and so forth. Terminologies associated with different technologies can vary. For example, depending on the technology considered, the User Equipment (UE) used in UMTS can sometimes be called a mobile station, a user terminal, a subscriber unit, an access terminal, etc., to name just a few. Likewise, Node B used in UMTS can sometimes be called an evolved Node B (eNodeB), an access node, an access point, a base station (BS), HRPD base station (BTS), and so forth. It should be noted here that different terminologies apply to different technologies when applicable.

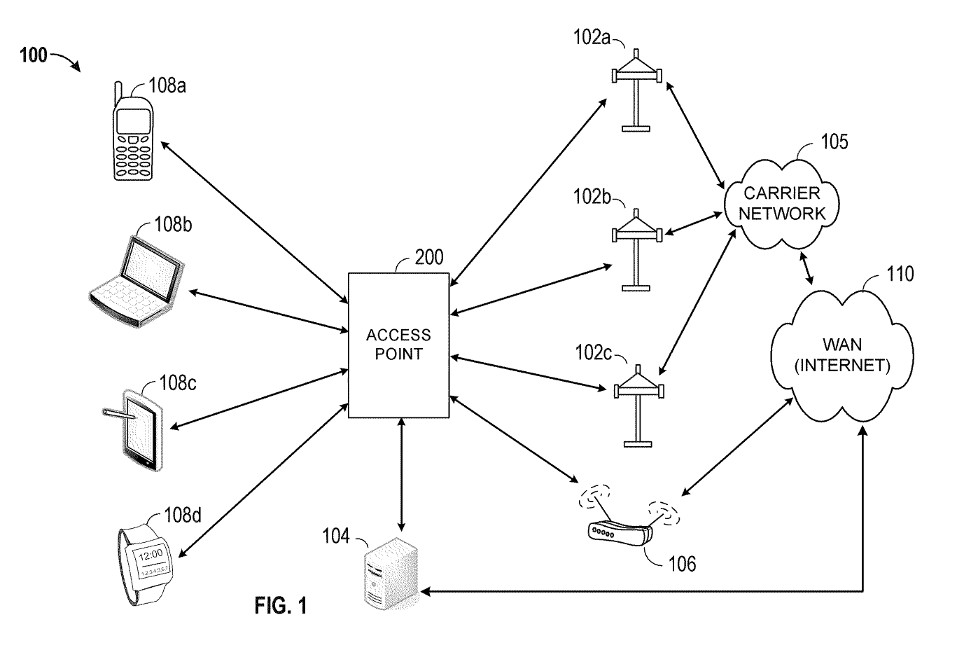

FIG. 1 illustrates an example of a wireless communication network 100 in which aspects of the present disclosure may be employed. The wireless communication network 100 may include a cellular access points (APs) 102a-c, Ethernet AP 104, and a Wi-Fi AP 106. Cellular AP 102a may provide access to a wireless cellular network such as a fourth generation (4G) long term evolution (LTE) wireless network, for 4G LTE-capable wireless devices within a basic service area for the cellular AP 102a. Similarly, cellular AP 102b may provide access to a cellular network such as code division multiple access (CDMA), and cellular AP 102c may provide access to a cellular network such as wideband CDMA (WCDMA). Cellular APs 102a-c may provide access to an IP network through a carrier network 105. The Ethernet AP 104 may provide direct access to an IP network, or may provide access to an IP network though an internet service provider (ISP) server. As illustrated, the Wi-Fi AP 106 may provide direct access to an IP network.

Via the wireless cellular network, the ISP server, or the IP network, access to a wide area network (WAN) 110 such as the Internet may be provided. In some aspects, the connection to the WAN 110 may provide a service to at least one of a plurality of client devices 108a, 108b, 108c, and 108d, hereinafter collectively referred to as STAs, UEs, service clients, or client devices 108. Examples of the services provided include voice-telephony, video conferencing, instant messaging, streaming media (e.g., audio, video, text), multimedia, monitoring, document processing, and the like. For example, IP multimedia subsystem (IMS) services may be provided, such as IMS voice.

Some client devices 108 may access cellular AP 102, Ethernet AP 104, or Wi-Fi AP 106 directly. In some implementations, the client devices 108 may access the WAN 110 via a software access point (SoftAP) 200. SoftAP 200 may refer to software running on an wireless device or apparatus that enables the wireless device or apparatus to provide network access to the client devices 108, or may refer to the wireless device or apparatus itself. In some aspects, SoftAP 200 may have additional functionalities, such as those provided by a personal computer or mobile wireless device. The SoftAP 200 may be referred to as a wireless relay device, wireless modem, or a mobile AP router. In some aspects, SoftAP may have 4G LTE capability. In some aspects, SoftAP 200 may support IMS services.

The SoftAP 200 may also comprise hard wired capabilities such that one or more wireless devices, for example the client devices 108, may utilize the SoftAP 200 as a relay device when connected to the SoftAP 200 via a hard wired connection, such as a universal serial bus (USB), for providing a connection between the client devices 108 and the WAN 110 via the networks at cellular AP 102 (e.g., 4G LTE network) or the Ethernet AP 104 (also referred to as “cradle” mode). The SoftAP 200 may further comprise a wireless relay or hotspot capability such that one or more wireless devices, for example the client devices 108, may utilize the SoftAP 200 as a wireless relay device or hotspot for providing a connection between the client devices 108 and the WAN via the networks at cellular AP 102 or the Wi-Fi AP 106. It will be appreciated that the SoftAP 200 may be configured to provide services to client devices via additional or alternative access points.

For the purposes of this application, an access point (AP) may comprise, be implemented as, or known as a Node B, Radio Network Controller (RNC), eNodeB, Base Station Controller (BSC), Base Transceiver Station (BTS), Base Station (BS), Transceiver Function (TF), Radio Router, Radio Transceiver, or some other terminology.

For the purposes of this application, a station (STA) may comprise, be implemented as, or known as an access terminal (AT), a subscriber station, a subscriber unit, a mobile station, a remote station, a remote terminal, a user terminal, a user agent, a user device, user equipment (UE), an IMS client or some other terminology. In some implementations an access terminal may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects disclosed herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a wireless sensor device, a global positioning system device, or any other suitable device that is configured to communicate via a wireless medium.

A variety of processes and methods may be used for transmissions in the wireless communication network 100 between the APs 102, 104, and 106 and the SoftAP 200 as well as between the client devices 108a-108d and the SoftAP 200. A communication link that facilitates transmission from any one of the APs 102, 104, or 106 to the SoftAP 200 or from the SoftAP 200 to any of the client devices 108a-108d may be referred to as a downlink (DL). A communication link that facilitates transmission from any of the client devices 108a-108d to the SoftAP 200 or from the SoftAP 200 to one of the APs 102, 104, or 106 may be referred to as an uplink (UL). Alternatively, a downlink may be referred to as a forward link or a forward channel, and an uplink may be referred to as a reverse link or a reverse channel.

One or more of the APs 102, 104, and 106 may be configured as a base station and provide wireless communication coverage in a basic service area (BSA) associated with the respective AP. Depending on the technology considered, a basic service area can sometimes be called a coverage area, cell, etc. An access point along with the SoftAP 200 and the client devices 108a-108d may be referred to as a basic service set (BSS).

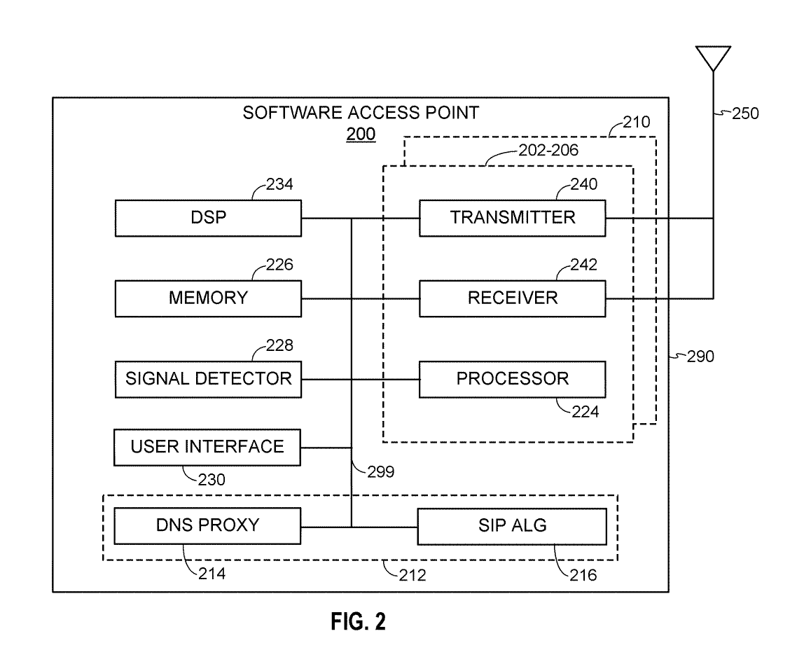

FIG. 2 illustrates an example of a functional block diagram of a SoftAP that may be employed within the wireless communication networks of FIG. 1. The SoftAP 200 is an example of a device that may be configured to implement the various methods described herein. The SoftAP 200 may be implemented as a wireless communication device such as a multimode or multiband device capable of operating using different radio access technologies (RATs), such as using Wi-Fi, LTE, LTE Advanced, HSPA, CDMA, HRPD, eHRPD, CDMA2000, GSM, GPRS, EDGE, UMTS, or the like.

The SoftAP 200 may include a mobile access point processor 224 which controls operation of the SoftAP 200. The mobile access point processor 224 may also be referred to as a central processing unit (CPU) or hardware processor. The mobile access point processor 224 is configured to control operation in the context of a mobile access point which includes efficient resource utilization which may increase performance and battery life. A memory 226, which may include both read-only memory (ROM) and random access memory (RAM), provides instructions and data to the mobile access point processor 224. A portion of the memory 226 may also include non-volatile random access memory (NVRAM). The mobile access point processor 224 typically performs logical and arithmetic operations based on program instructions stored within the memory 226. The instructions in the memory 226 may be executable to implement the methods described herein.

The data in memory 226 may include configuration data. Configuration data may be preloaded into the memory 226. Configuration data may be obtained from a user of the SoftAP 200 (e.g., through a user interface 230, SIM card, download, over the air). The mobile access point processor 224 may perform logical and arithmetic operations further based on the configuration data. Accordingly, in some aspects, mobile access point processor 224 operating based on configuration data may be referred to, herein, as a configuration module.

In some aspects, the mobile access point processor 224 is configured to cause signals to be sent to and to be received from another device (e.g., the cellular APs 102a-c, the Ethernet AP 104, the Wi-Fi AP 106, the client devices 108a-108d, etc.). The mobile access point processor 224 may be further configured to enforce access permissions.

The mobile access point processor 224 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include non-transitory computer-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions or code, when executed by the one or more processors, cause the processing system to perform the various functions described herein.

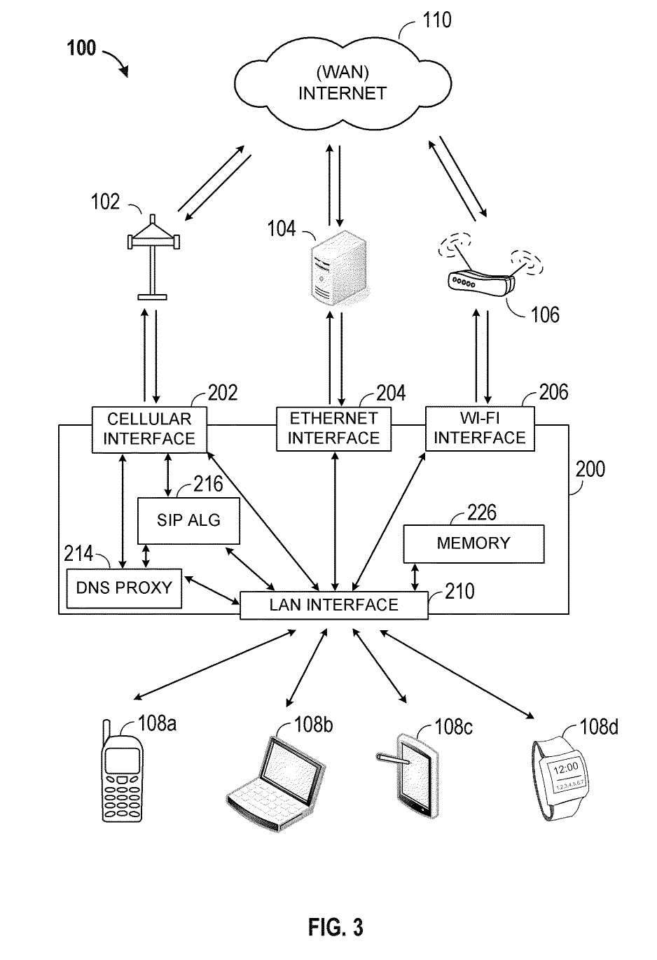

To facilitate communication with APs, the SoftAP 200 includes network interfaces to the APs (e.g., client interfaces 202-206). In some implementations, these may be referred to as client interfaces because they allow the SoftAP 200 to communicate as a client device with the AP providing access to the wide area network 110. As shown in FIG. 2 (and in further detail in FIG. 3), the SoftAP 200 includes a cellular interface 202, an Ethernet interface 204, and a Wi-Fi interface 206. Although the discussion uses cellular, Ethernet, and Wi-Fi as example client interfaces, other communication network technologies may be provide via additional client interfaces such as an IEEE 802.15.1 (e.g., Bluetooth™) interface, or the like. The interfaces may be implemented as network cards providing access via the protocol for the associated AP. In some implementations, the interfaces may be implemented using common components such as a wired and/or wireless signal card which is specially configured to distinguish various radio access technologies.

Each of the client interfaces 202-206 and the LAN interface 210 may include a transmitter 240 and/or a receiver 242 to allow transmission and reception of data between the SoftAP 200 and one or more target remote locations. The transmitter 240 and receiver 242 may be combined into a transceiver. It will be appreciated that the transmitter 240 and/or receiver 242 may be multiplexed to allow the same transmitter 240 and/or receiver 242 to be used for multiple interfaces (e.g., client interface and serving interface). An antenna 250 (or multiple antennas) may be attached to the housing 290 and electrically coupled to one or more transceivers for wireless communications. The SoftAP 200 may also include (not shown) multiple transmitters, multiple receivers, multiple transceivers, and/or multiple antennas.

The SoftAP 200 may also include a signal detector 228 that may be used in an effort to detect and quantify the level of signals received by the transceiver or receiver 242. The signal detector 228 may detect such signals as total energy, energy per subcarrier per symbol, power spectral density, and other signals. The SoftAP 200 may also include a digital signal processor (DSP) 234 for use in processing signals. The DSP 234 may be configured to generate a packet for transmission and/or process a received packet.

In some aspects, the SoftAP 200 may further comprise a user interface 230. The user interface 230 may comprise a keypad, a microphone, a speaker, and/or a display. The user interface 230 may include any element or component that conveys information to a user of the SoftAP 200 and/or receives input from the user.

The SoftAP 200 shown in FIG. 2 also includes a LAN interface 210. The LAN interface 210 provides network access to the client devices 108a-108d. Accordingly, the SoftAP 200 may appear to the client devices 108a-108d as a Wi-Fi access point. As illustrated, LAN interface 210 comprises mobile access point processor 224. In some aspects, LAN interface 210 may be configured to identify which client interface 202-206 to utilize for client device communications. The LAN interface 210 may utilize configuration information stored in the memory 226 to identify the proper client interface. For example, the LAN interface 210 may utilize information included in a packet of data such as the destination address or destination port to identify which communication channel the packet is intended for (e.g., one of cellular APs 102a-c, Ethernet AP 104, or Wi-Fi AP 106). In various aspects, the LAN interface 210 may utilize installed policy based routes. The LAN interface 210 may include a packet selection system configured for packet filtering, network address translation, or packet mangling (e.g., altering a value included in the packet such as source address). In some aspects, client interface 202-206 may comprise a processor, such as mobile access point processor 224, and each may perform some of the functionalities of LAN interface 210 described herein.

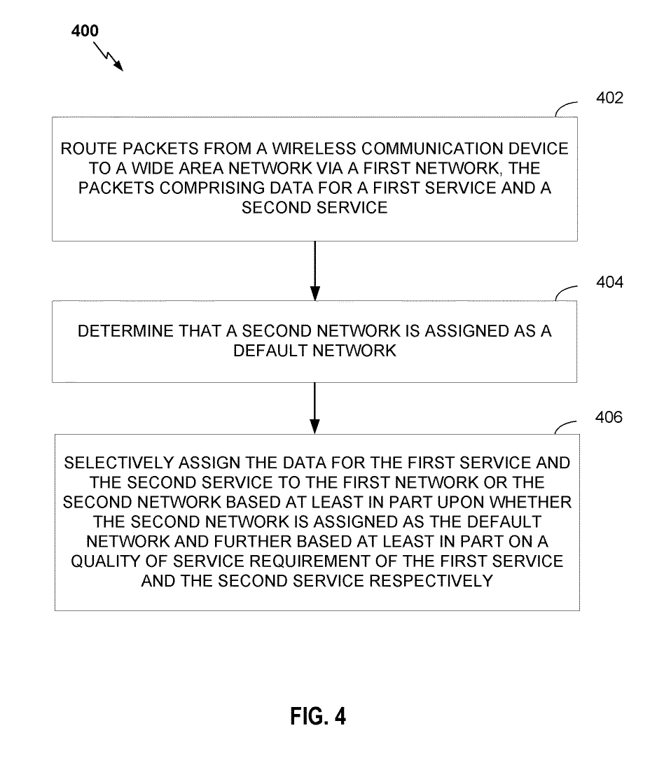

The SoftAP 200 may include a traffic router 212. Traffic router may comprise a domain name server (DNS) proxy server 214 and a session initiation protocol application-level gateway (SIP ALG) 216. In various embodiments, traffic router 212 may additionally (or alternatively from the description of LAN interface 210 above) identify which client interface 202-206 to utilize for client device communications. For uplink traffic (e.g., traffic transmitted from a client device 108 to the wide area network 110), packet data can be received at the LAN interface 210 and provided to the traffic router 212. The traffic router 212 may then determine which AP network interface to utilize for the data (as discussed in further detail below with respect to DNS proxy server 214 and SIP ALG 216 in FIG. 4). In some aspects, the traffic router 212 may utilize information included in a packet of data such as an SIP address or a fully qualified DNS address to identify which communication channels over which the packet should be transmitted. The traffic router 212 may also utilize configuration information stored in the memory 226 to identify the appropriate client interface.

If traffic router 212 determines that, for example, received data is intended for the Wi-Fi AP 106, but the received data contains a SIP address of a particular value stored in memory 226, the traffic router 212 may dynamically adjust the route for the received data to flow via the cellular interface 202 rather than via the Wi-Fi interface 206. This may occur, for example, when the SoftAP is routing at least a portion of the traffic over Wi-Fi AP 106, but the received data is QOS dependent. As a non-limiting example of a benefit, routing this QOS dependent data over a cellular AP 102 instead of Wi-Fi AP 106 may decrease the likelihood of terminating or dropping the data service, such as an IMS service.

In one implementation, the traffic router 212 may utilize a routing table. The routing table can include one or more entries identifying how information received from a source should be transmitted to a destination. In some aspects, the traffic router 212 may include a packet selection system configured for packet filtering, network address translation, or packet mangling (e.g., altering a value included in the packet such as source address).

As routing decisions are made by the traffic router 212, the information may be stored in the memory 226. In such implementations, a cache of routing decisions may be maintained for a given period of time. The decisions may be cached per device, per destination address, per destination port, or some combination thereof.

The various components of the SoftAP 200 may be coupled together by a bus system 299. The bus system 299 may include a data bus, for example, as well as a power bus, a control signal bus, and a status signal bus in addition to the data bus. Those of skill in the art will appreciate the components of the SoftAP 200 may be coupled together or accept or provide inputs to each other using some other mechanism.

Although a number of separate components are illustrated in FIG. 2, those of skill in the art will recognize that one or more of the components may be combined or commonly implemented. For example, the mobile access point processor 224 may be used to implement not only the functionality described above with respect to the mobile access point processor 224, but also to implement the functionality described above with respect to the signal detector 218 and/or the DSP 220. Further, each of the components illustrated in FIG. 2 may be implemented using a plurality of separate elements. For example, the mobile access point processor 224 and the memory 226 may be embodied on a single chip. The mobile access point processor 224 may additionally, or in the alternative, contain memory, such as processor registers. Similarly, one or more of the functional blocks or portions of the functionality of various blocks may be embodied on a single chip. Alternatively, the functionality of a particular block may be implemented on two or more chips.

In this specification and the appended claims, it should be clear that the terms “circuit” and “circuitry” are construed as a structural terms and not as functional terms. For example, circuitry can be an aggregate of circuit components, such as a multiplicity of integrated circuit components, in the form of processing and/or memory cells, units, blocks, and the like, such as shown and described in FIG. 2. One or more of the functional blocks and/or one or more combinations of the functional blocks described with respect to the SoftAP 200 may also be implemented as a combination of computing devices, e.g., a combination of a DSP and a microprocessor, a plurality of microprocessors, one or more microprocessors in conjunction with a DSP communication, or any other such configuration.

In some other implementations, a command line interface and/or graphical user interface (GUI) may be provided at or by the SoftAP 200 via at least the user interface 230 and may allow for receipt of data to setup or configure routing parameters and/or blockage detection for the SoftAP 200. In other implementations, the command line interface or GUI may be presented via one or more of the client devices 108a-108d or the input values may be passed to the SoftAP 200 for storage and utilization in routing. For example, the user interface 230 may provide configuration information for various available connections, such as a listing of alternate networks which may be used for connecting to the desired service. Policy based routes may be installed for the traffic router 212 causing the traffic router 212 to route the specified connections over the specified connection instead of a connection otherwise selected by the SoftAP 200.

FIG. 3 illustrates another example of the wireless communication network 100 in which aspects of the present disclosure may be employed. The wireless communication network 100 may include cellular AP 102 (also referred to as WWAN backhaul), Ethernet AP 104 (also referred to as a cradle backhaul), Wi-Fi AP 106 (also referred to as a WLAN backhaul), SoftAP 200, and client devices 108a-d. In some aspects, the SoftAP 200 may comprise a mobile data modem (MDM) chipset.

As shown in FIG. 3, the SoftAP 200 includes a cellular interface 202, an Ethernet interface 204, and a Wi-Fi interface 206, which may collectively be referred to herein as client interfaces 202-206. The SoftAP 200 shown in FIG. 3 also includes a serving local area network (LAN) interface 210. The LAN interface 210 can provide network access to the client devices 108, either wirelessly, through a wired connection, or both. In some aspects, SoftAP 200 may appear to the client devices 108 as a Wi-Fi AP. LAN interface 210 may provide and receive data directly from client interfaces 202-206, or may provide and receive data indirectly from client interfaces 202-206 through the use of an intermediary component or application, such as a DNS proxy server 214 or a session initiation protocol application-level gateway (SIP ALG) 216.

In some aspects, SoftAP 200 may dynamically switch among the client interfaces 202-206. This switching may occur due to various factors. For instance, in one embodiment, SoftAP 200 may initially provide WWAN access to client devices 108 (e.g., cellular access), and may thereafter detect a preconfigured WLAN (e.g., Wi-Fi) hotspot. In accordance with this embodiment, SoftAP 200 may become associated with the hotspot and have an IP address assigned. At this time, backhaul access to the client devices 108 may be changed from WWAN to WLAN. In accordance with this embodiment, backhaul access to the client devices 108 may only be changed from WWAN to WLAN if a default backhaul, WAN connection, or gateway of the SoftAP 200 is changed or otherwise configured to change to WLAN. In some embodiments, SoftAP 200 may initially provide WWAN access to client devices 108 which may have a cradle mode enabled. In accordance with these embodiments, SoftAP 200 may detect when a client device 108 is docked (e.g., connected to a computer via USB), and may have an IP address assigned to the Ethernet interface 204. At this time, the backhaul access to the client devices 108 may be changed from WWAN to cradle. In accordance with these embodiments, backhaul access to the client devices 108 may only be changed from WWAN to Ethernet if a default backhaul, WAN connection, or gateway of the SoftAP 200 is changed or otherwise configured to change to Ethernet.

When dynamically switching the backhaul networks as described above, all of the data traffic may be routed through the new backhaul (e.g., WLAN or cradle), and none of the data may be routed through the prior backhaul (e.g., WWAN). However, this may cause problems with certain forms of data, such as, for example, IMS data. In some aspects, a dedicated bearer is set up for communication of IMS data over the WWAN network accessed via cellular AP 102. In these aspects, a special registration node, known as a SIP registrar may only be accessible through the WWAN network, and may not be accessible over the WLAN backhaul or the cradle backhaul. Accordingly, if all of the data traffic is routed through the WLAN or cradle backhaul, the SIP registrar may not be accessible, and the IMS data may not be used by the client devices 108. In one exemplary embodiment, client device 108a may be accessing the WAN 110 via the cellular interface 202 of SoftAP 200, and may wish to initiate an IMS voice call. In accordance with this embodiment, client device 108a may set up the IMS voice call through a SIP registrar accessible via cellular AP 102. When SoftAP 200 detects a Wi-Fi hotspot, or detects that client device 108a is docked, SoftAP 200 may route all data over the respective associated WLAN or cradle backhauls. Thus, the SIP registrar may no longer be accessible, and the IMS voice call may be dropped.

Routing all of the data traffic over a WLAN backhaul or a cradle backhaul may also cause issues for applications running on a client device 108 requiring a particular quality of service (QOS). In some embodiments, client devices 108 accessing the WAN 110 through the WWAN backhaul may request a minimum QOS for an application, and the QOS may be granted by the cellular AP 102 using network initiated QOS procedures. However, when the backhaul is switched from WWAN to WLAN or cradle, this granted QOS is no longer available, and may lead to a poor experience at the client device 108. In one exemplary embodiment, client device 108a may be granted a minimum QOS over WWAN when initiating an IMS voice call. In accordance with this embodiment, if SoftAP 200 begins to route data over the WLAN or cradle backhauls, the IMS voice call may no longer have a guaranteed QOS, and the IMS voice call may be of poor quality, or may even be dropped.

Accordingly, methods for intelligently routing IMS data traffic from client devices 108 in a multiple backhaul scenario are provided. In various aspects, a portion of the data traffic is routed over at least one backhaul, while the remainder of the data traffic is routed over at least one other backhaul. In an exemplary embodiment where more than one backhaul is available to SoftAP 200, IMS data is routed over the WWAN backhaul, and the remainder of the non-QOS dependent data is routed over the WLAN or cradle backhaul. In some aspects, data may only be routed in this manner if a default backhaul, WAN connection, or gateway of the SoftAP 200 is changed or is otherwise configured to change (e.g., from cellular to WLAN or Ethernet).

In one embodiment, the WWAN network provides a proxy call session control function (PCSCF) server IP address to the clients. In accordance with this embodiment, after initial session initiated protocol (SIP) signaling is completed (e.g., with the SIP server accessible through cellular AP 102), SIP data port information may be extracted from SIP ALG 216 and policy based routes will be installed on the SIP data ports to route those packets over WWAN. The policy based routes may be installed within the SoftAP 200, and in some aspects, the policy based routes may be installed within the LAN interface 210. These policy based routes may be installed based on the rule that the destination address matches with the PCSCF gateway address. In this embodiment, an IP address may be provided to a client device 108 using WWAN for a QOS dependent application. In some aspects, the IP address is provided by the SIP server of the WWAN network. In accordance with this embodiment, all of the initial SIP traffic destined to a SIP gateway address will be routed over WWAN. In some aspects, LAN interface 210 may route this traffic directly to the cellular interface 202, or may indirectly route this traffic to the cellular interface 202, for example, through SIP ALG 216. As a result, the SIP data traffic may be routed over WWAN instead of the WLAN or cradle backhauls.

In another embodiment, the WWAN network provides PCSCF fully qualified domain name (FQDN) address to the clients. In various aspects, client devices 108 try to resolve a PCSCF FQDN address when trying to make a SIP call, which in some aspects, may only be resolved over the WWAN network. As illustrated, SoftAP 200 comprises a DNS proxy server 214, which may look for resolution of the PCSCF FQDN address. From a DNS response, the PCSCF gateway address may be fetched and policy based routes may be installed to route packets over the WWAN backhaul instead of the WLAN or cradle backhaul. The policy based routes may be installed within the SoftAP 200, and in some aspects, the policy based routes may be installed within the LAN interface 210. These policy based routes may be installed based on the rule that the destination address matches with the PCSCF gateway address. In some aspects, DNS proxy server 214 may forward a client device 108 PCSCF FQDN address request to the DNS server of the WWAN network, instead of the WLAN or cradle backhaul. Additionally or alternatively, after initial SIP signaling is completed, SIP data port information may be extracted and policy based routes may be installed on the SIP data ports so that all of the initial SIP traffic destined to a SIP gateway address will be routed over WWAN, similar to the embodiments described above. In some aspects, LAN interface 210 may route the traffic comprising QOS dependent application information directly to the cellular interface 202, or may indirectly route this traffic to the cellular interface 202, for example, through DNS proxy server (which may in turn route the traffic through SIP ALG 216).

In some aspects, the policy based routes described above may only be installed if a default backhaul, WAN connection, or gateway of the SoftAP 200 is changed or is otherwise configured to change (e.g., from cellular to WLAN or Ethernet). In accordance with these aspects, the SoftAP 200 may be configured to first determine whether an available WLAN or Ethernet backhaul is configured to become the default backhaul, WAN connection, or gateway. Upon determining that the available WLAN or Ethernet backhaul is configured in this manner, the SoftAP 200 may be further configured to install one or more of the policy based routes described herein. In one embodiment, the determination and installation may be performed in part by the mobile access point processor 224.

FIG. 4 illustrates a process flow diagram of a method 400 of providing wireless communications. The method 400 may be implemented in whole or in part by, or in connection with, the devices described herein such as the SoftAP 200 shown in FIGS. 1-3. Those having ordinary skill in the art will appreciate that other components may be used to implement one or more of the steps described herein. Although blocks may be described as occurring in a certain order, the blocks can be reordered, blocks can be omitted, and/or additional blocks can be added.

At block 402, packets from a wireless communication device are routed to a wide area network via a first network, the packets comprising data for a first service and a second service. In some aspects, the first network comprises a wireless wide area network (WWAN) and the second network comprises a wireless local area network (WLAN) or an Ethernet network. In an exemplary embodiment, the first service comprises a service requiring a minimum quality of service. For example, the first service may comprise an IP multimedia subsystem (IMS) service, such as IMS voice. In various aspects, the first network and the second network are backhaul networks provided to the wireless communication device via an access point. In some aspects, the access point is configured to dynamically switch between the first network and second network (e.g., between a WWAN network and a WLAN network).

At block 404, a determination is made as to whether a second network is assigned as a default network (e.g., a default backhaul, WAN connection, or gateway). In some embodiments, the default network may refer to a network connection that, upon becoming available, is the network over which all or substantially all of data or traffic is routed. In some aspects, additionally or alternatively, the method 400 may further include determining whether an external Wi-Fi hotspot is available or whether the wireless communication device is in a cradle mode (e.g., connected to a hard wired network connection such as Ethernet). In accordance with these aspects, the method may further include selectively assigning the data for the first service and the second service to the first network or the second network based at least in part on whether the external Wi-Fi hotspot is available or whether the wireless communication device is in the cradle mode.

At block 406, the data for the first service and the second service is selectively assigned to the first network or the second network based at least in part upon whether the second network is assigned as the default network and further based at least in part on a quality of service requirement of the first service and the second service respectively. In some aspects, selectively assigning the data for the first service to the first network comprises using policy based routes. In some embodiments, the policy based routes utilize a session initiated protocol address. In some embodiments, the policy based routes utilize a fully qualified domain name server address. In some embodiments, the first and the second services may only be selectively assigned if the second network is configured as the default network. For example, installing or otherwise utilizing policy based routes may only occur if the detected second network is configured as the default network.

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations. For instance, in various aspects, means for routing packets from a wireless communication device to a wide area network via a first network may comprise one or more of the mobile access point processor 224, receiver 242, transmitter 240, LAN interface 210, cellular interface 202, Ethernet interface 204, Wi-Fi interface 206, traffic router 212, DNS proxy server 214, SIP ALG 216, memory 226, or their functional equivalents, as described herein. In one aspect, means for routing packets from a wireless communication device to a wide area network via a first network may comprise receiving packets from the wireless communication device, processing at least a portion of the packet, determining a destination of the packet based on the processing, transmitting the packet to an interface corresponding to the determined destination, and transmitting the packet to an access point associated with the first network. The associated access point may, in turn, transmit the packet to the wide area network.

In various aspects, means for determining that a second network is assigned as a default network may comprise one or more of mobile access point processor 224, receiver 242, transmitter 240, Ethernet interface 204, Wi-Fi interface 206, memory 226, or their functional equivalents, as described herein. In one aspect, the apparatus comprising the means for determining that a second network is assigned as a default network may receive information from an access point associated with the second network indicating that the second network is available to provide access to the wide area network (e.g., Internet), and this indication may be processed to determine whether the second network is available or assigned as a default network. In some aspects this received information may come from a wireless connection, such as a wireless communication receiver, and it may be determined that a Wi-Fi hotspot is available and/or assigned as a default network. In some aspects, this received information may come from a hard wired connection, such as a USB, and it may be determined that the wireless communication device is in a cradle mode, that an Ethernet connection is available, and/or assigned as a default network.

In some aspects, means for selectively assigning the data for the first service and the second service to the first network or the second network based at least in part upon a quality of service requirement may comprise one or more of the mobile access point processor 224, receiver 242, transmitter 240, LAN interface 210, cellular interface 202, Ethernet interface 204, Wi-Fi interface 206, traffic router 212, DNS proxy server 214, SIP ALG 216, memory 226, or their functional equivalents, as described herein. In one aspect, means for selectively assigning the data for the first service and the second service to the first network or the second network based at least in part upon a quality of service requirement may comprise installing a policy based route based on an SIP or DNS value of a service requiring a minimum quality of service. In accord, packets corresponding to the SIP or DNS values may be selectively forwarded to a cellular AP, a Wi-Fi AP, or an Ethernet AP based on a processing of the packet. In one aspect, settings of the apparatus or the wireless communication device may be checked to determine whether the assignment should be made (e.g., based on a user or device setting).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-Ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of providing wireless communications, comprising:
routing packets from a wireless communication device to a wide area network via a first network, the packets comprising data for a first service and a second service;
determining that a second network is assigned as a default network; and
selectively assigning the data for the first service and the second service to the first network or the second network based at least in part upon whether the second network is assigned as the default network and further based at least in part on a quality of service requirement of the first service and the second service respectively.

2. The method of claim 1, wherein the first network comprises a wireless wide area network (WWAN), wherein the second network comprises a wireless local area network (WLAN) or an Ethernet network, and wherein the first service comprises a service requiring a minimum quality of service.

3. The method of claim 2, wherein the first service is an IP multimedia subsystem (IMS) service.

4. The method of claim 2, further comprising:
determining whether an external Wi-Fi hotspot is available or whether the wireless communication device is in a cradle mode; and
selectively assigning the data for the first service and the second service to the first network or the second network based at least in part on whether the external Wi-Fi hotspot is available or whether the wireless communication device is in the cradle mode.

5. The method of claim 1, wherein the first network and the second network are backhaul networks provided to the wireless communication device via an access point configured to dynamically switch between the first network and second network.

6. The method of claim 1, wherein selectively assigning the data for the first service to the first network comprises using policy based routes.

7. The method of claim 6, wherein the policy based routes utilize a session initiated protocol address.

8. The method of claim 6, wherein the policy based routes utilize a fully qualified domain name server address.

9. An apparatus configured to provide wireless communications, comprising:
a processor configured to:
route packets from a wireless communication device to a wide area network via a first network, the packets comprising data for a first service and a second service;
determine that a second network is assigned as a default network; and
selectively assign the data for the first service and the second service to the first network or the second network based at least in part upon whether the second network is assigned as the default network and further based at least in part on a quality of service requirement of the first service and the second service respectively.

10. The apparatus of claim 9, wherein the first network comprises a wireless wide area network (WWAN), wherein the second network comprises a wireless local area network (WLAN) or an Ethernet network, and wherein the first service comprises a service requiring a minimum quality of service.

11. The apparatus of claim 10, wherein the first service is an IP multimedia subsystem (IMS) service.

12. The apparatus of claim 10, wherein the processor is further configured to:
determine whether an external Wi-Fi hotspot is available or whether the wireless communication device is in a cradle mode; and
selectively assign the data for the first service and the second service to the first network or the second network based at least in part on whether the external Wi-Fi hotspot is available or whether the wireless communication device is in the cradle mode.

13. The apparatus of claim 9, wherein the apparatus comprises an access point, and wherein the processor is further configured to:
provide the first network and the second network to the wireless communication device via dynamically switching between the first network and second network, wherein the first network and the second network are backhaul networks.

14. The apparatus of claim 9, wherein the processor is further configured to:
selectively assign the data for the first service to the first network using policy based routes.

15. The apparatus of claim 14, wherein the policy based routes utilize a session initiated protocol address.

16. The apparatus of claim 14, wherein the policy based routes utilize a fully qualified domain name server address.

17. An apparatus configured to provide wireless communications, comprising:
means for routing packets from a wireless communication device to a wide area network via a first network, the packets comprising data for a first service and a second service;
means for determining that a second network is assigned as a default network; and
means for selectively assigning the data for the first service and the second service to the first network or the second network based at least in part upon whether the second network is assigned as the default network and further based at least in part on a quality of service requirement of the first service and the second service respectively.

18. The apparatus of claim 17, wherein the first network comprises a wireless wide area network (WWAN), wherein the second network comprises a wireless local area network (WLAN) or an Ethernet network, and wherein the first service comprises a service requiring a minimum quality of service.

19. The apparatus of claim 18, wherein the first service is an IP multimedia subsystem (IMS) service.

20. The apparatus of claim 18, wherein the apparatus comprises an access point comprising:
means for determining whether an external Wi-Fi hotspot is available or whether the wireless communication device is in a cradle mode; and
means for selectively assigning the data for the first service and the second service to the first network or the second network based at least in part on whether the external Wi-Fi hotspot is available or whether the wireless communication device is in the cradle mode.

21. The apparatus of claim 17, further comprising:
means for providing the first network and the second network to the wireless communication device via dynamically switching between the first network and second network, wherein the first network and the second network are backhaul networks.

22. The apparatus of claim 17, further comprising:
means for selectively assigning the data for the first service to the first network using policy based routes that utilize a session initiated protocol address.

23. The apparatus of claim 17, further comprising:
means for selectively assigning the data for the first service to the first network using policy based routes that utilize a fully qualified domain name server address.

24. A non-transitory computer readable medium comprising code that, when executed, performs a method of providing wireless communications, the method comprising:
routing packets from a wireless communication device to a wide area network via a first network, the packets comprising data for a first service and a second service;
determining that a second network is assigned as a default network; and
selectively assigning the data for the first service and the second service to the first network or the second network based at least in part upon whether the second network is assigned as the default network and further based at least in part on a quality of service requirement of the first service and the second service respectively.

25. The non-transitory computer readable medium of claim 24, wherein the first network comprises a wireless wide area network (WWAN), wherein the second network comprises a wireless local area network (WLAN) or an Ethernet network, and wherein the first service comprises a service requiring a minimum quality of service.

26. The non-transitory computer readable medium of claim 25, wherein the first service is an IP multimedia subsystem (IMS) service.

27. The non-transitory computer readable medium of claim 25, wherein the method further comprises:
determining whether an external Wi-Fi hotspot is available or whether the wireless communication device is in a cradle mode; and
selectively assigning the data for the first service and the second service to the first network or the second network based at least in part on whether the external Wi-Fi hotspot is available or whether the wireless communication device is in the cradle mode.

28. The non-transitory computer readable medium of claim 24, wherein the first network and the second network are backhaul networks provided to the wireless communication device via an access point configured to dynamically switch between the first network and second network.

29. The non-transitory computer readable medium of claim 24, wherein selectively assigning the data for the first service to the first network comprises using policy based routes that utilize a session initiated protocol address.

30. The non-transitory computer readable medium of claim 24, wherein selectively assigning the data for the first service to the first network comprises using policy based routes that utilize a fully qualified domain name server address.
